(19) United States
(12) Patent Application Publication
(10) Pub. No.: US 2024/0174132 A1
(43) Pub. Date: May 30, 2024

(54) VEHICLE

(71) Applicant: HONDA MOTOR CO., LTD., Tokyo (JP)

(72) Inventors: Soichi MORII, Saitama (JP); Yasuo YAMADA, Saitama (JP); Yasushi OGIHARA, Saitama (JP)

(73) Assignee: HONDA MOTOR CO., LTD., Tokyo (JP)

(21) Appl. No.: 18/523,388

(22) Filed: Nov. 29, 2023

(30) Foreign Application Priority Data
Nov. 30, 2022 (JP) 2022-192127

(51) Int. Cl. B60L 58/20; B60L 58/19; B60W 10/26

(52) U.S. Cl. CPC B60L 58/20; B60L 58/19; B60W 10/26; B60L 2240/547

(57) ABSTRACT

A vehicle includes a drive source, a battery and a controller. The battery includes two storages, a positive node connecting positives of the storages, a negative node connecting negatives of the storages, a connection circuit connecting the negative of the first storage and the positive of the second storage, a first contactor in the connection circuit, a second contactor and a first fuse provided between the positive node and a first connection portion connecting the positive of the second storage and the connection circuit, and a third contactor and a second fuse provided between the negative node and a second connection portion connecting the negative of the first storage and the connection circuit. The controller switches between a first state where the storages are connected in series and chargeable at a first voltage and a second state where the storages are connected in parallel and chargeable at a second voltage.

### CROSS-REFERENCE TO RELATED APPLICATIONS

This application is based on and claims priority under 35 USC 119 from Japanese Patent Application No. 2022-192127 filed on Nov. 30, 2022, the entire content of which is incorporated herein by reference.

### TECHNICAL FIELD

The present disclosure relates to a vehicle.

### BACKGROUND ART

In recent years, researches and developments have been conducted on charging and power supplying for a vehicle provided with a secondary battery, which contributes to energy efficiency, in order to allow more people to have access to affordable, reliable, sustainable and advanced energy.

In relation to charging and power supplying in a vehicle provided with a secondary battery, there are two types of charging equipment such as charge stations which are compatible with 400 V class and 800 V class. When a vehicle is compatible to only 400 V class compatible charging equipment, in 800 V class compatible charging equipment, the vehicle cannot enjoy the quick charging performance of the 800 V class compatible charging equipment.

In a case where the vehicle is both compatible with the 400 V class compatible charging equipment and the 800 V class compatible charging equipment, generally, a voltage is boosted to 800 V by a voltage converter when charging by the 400 V class compatible charging equipment, or the voltage is stepped down to 400 V by the voltage converter when charging by the 800 V class compatible charging equipment. However, using such a voltage converter for charging deteriorates efficiency during charging.

In this regard, there is known a vehicle which switches a connection system of a battery module so as to be chargeable by both 400 V class compatible charging equipment and 800 V class compatible charging equipment without using any voltage converter for charging (for example, see JP2019-080474A and JP2020-150618A).

In such a vehicle, an overcurrent may flow through a battery due to an internal short circuit or the like during charging or switching. The vehicle is preferably configured to be able to travel to home, a dealer, or a repair shop while protecting a battery even when an overcurrent flows through the battery.

### SUMMARY OF INVENTION

The present disclosure provides a vehicle capable of traveling even in an emergency while protecting a battery.

A first aspect of the present disclosure relates to a vehicle including a drive source, a battery that supplies electric power to the drive source, and a controller configured to control the drive source and the battery,
in which the battery has:
   a first power storage;
   a second power storage;
   a positive node configured to connect in parallel a positive terminal of the first power storage and a positive terminal of the second power storage;
   a negative node configured to connect in parallel a negative terminal of the first power storage and a negative terminal of the second power storage;
   a connection circuit configured to connect the negative terminal of the first power storage and the positive terminal of the second power storage;
   a first contactor provided in the connection circuit;
   a second contactor and a first fuse provided between the positive node and a first connection portion configured to connect the positive terminal of the second power storage and the connection circuit; and
   a third contactor and a second fuse provided between the negative node and a second connection portion configured to connect the negative terminal of the first power storage and the connection circuit, and
in which the controller is configured to switch between
a first voltage state in which the first contactor is in an on state, the second contactor and the third contactor are in an off state, and the first power storage and the second power storage are connected in series and chargeable at a first voltage, and
a second voltage state in which the first contactor is in an off state, the second contactor and the third contactor are in an on state, and the first power storage and the second power storage are connected in parallel and chargeable at a second voltage.

A second aspect of the present disclosure relates to a vehicle including a drive source, a battery that supplies electric power to the drive source, and a controller that controls the drive source and the battery,
in which the battery has:
   a first power storage;
   a second power storage;
   a positive node configured to connect in parallel a positive terminal of the first power storage and a positive terminal of the second power storage;
   a negative node configured to connect in parallel a negative terminal of the first power storage and a negative terminal of the second power storage;
   a connection circuit configured to connect the negative terminal of the first power storage and the positive terminal of the second power storage;
   a first contactor and a fuse provided in the connection circuit;
   a second contactor provided between the positive node and a first connection portion configured to connect the positive terminal of the second power storage and the connection circuit; and
   a third contactor provided between the negative node and a second connection portion configured to connect the negative terminal of the first power storage and the connection circuit, and
in which the controller is configured to switch between
a first voltage state in which the first contactor is an on state, the second contactor and the third contactor are in an off state, and the first power storage and the second power storage are connected in series and chargeable at a first voltage, and
a second voltage state in which the first contactor is in an off state, the second contactor and the third contactor are in an on state, the first power storage and the second power storage are connected in parallel and chargeable at a second voltage.

According to the present disclosure, it is possible to provide a vehicle that can travel even in an emergency while protecting a battery.

### BRIEF DESCRIPTION OF DRAWINGS

Exemplary embodiment(s) of the present invention will be described in detail based on the following figures, wherein:

FIG. 1 shows a configuration of a vehicle 100 according to an embodiment of the present disclosure;

FIG. 2 shows a first voltage state (800 V startup) of a battery 2;

FIG. 3 shows a second voltage state (400 V startup) of the battery 2;

FIG. 4 shows a current flow during traveling of the vehicle 100;

FIG. 5 shows a current flow during charging the vehicle 100 at a first voltage (800 V);

FIG. 6 shows a current flow during charging the vehicle 100 at a second voltage (400 V):

FIG. 7 shows an operation sequence during traveling of the vehicle 100;

FIG. 8 shows an operation sequence during charging the vehicle 100 at the first voltage (800 V);

FIG. 9 shows an operation sequence during charging the vehicle 100 at the second voltage (400 V);

FIG. 10 shows a current flow in the battery 2 when a first contactor S/C_A is stuck in an OFF state:

FIG. 11 shows a current flow in the battery 2 when a second contactor S/C_B is stuck in an OFF state:

FIG. 12 shows a current flow in the battery 2 when the first contactor S/C_A is stuck in an ON state:

FIG. 13 shows a current flow in the battery 2 when the second contactor S/C_B is stuck in an ON state;

FIG. 14 shows a warning screen G1 displayed when a failure occurs in a battery switching circuit;

FIG. 15 shows a warning screen G2 displayed when a failure occurs in a battery switching circuit;

FIG. 16 shows a configuration of a vehicle 100B according to a first modification;

FIG. 17 shows a configuration of a vehicle 100C according to a second modification;

FIG. 18 shows a configuration of a vehicle 100D according to a third modification;

FIG. 19 shows a configuration of a vehicle 100E according to a fourth modification;

FIG. 20 shows a configuration of a vehicle 100F according to a fifth modification;

FIG. 21 shows a configuration of a vehicle 100G according to a sixth modification; and

FIG. 22 shows a configuration of a vehicle 100H according to a seventh modification.

### DESCRIPTION OF EMBODIMENTS

Hereinafter, an embodiment of a vehicle of the present disclosure will be described with reference to the drawings.

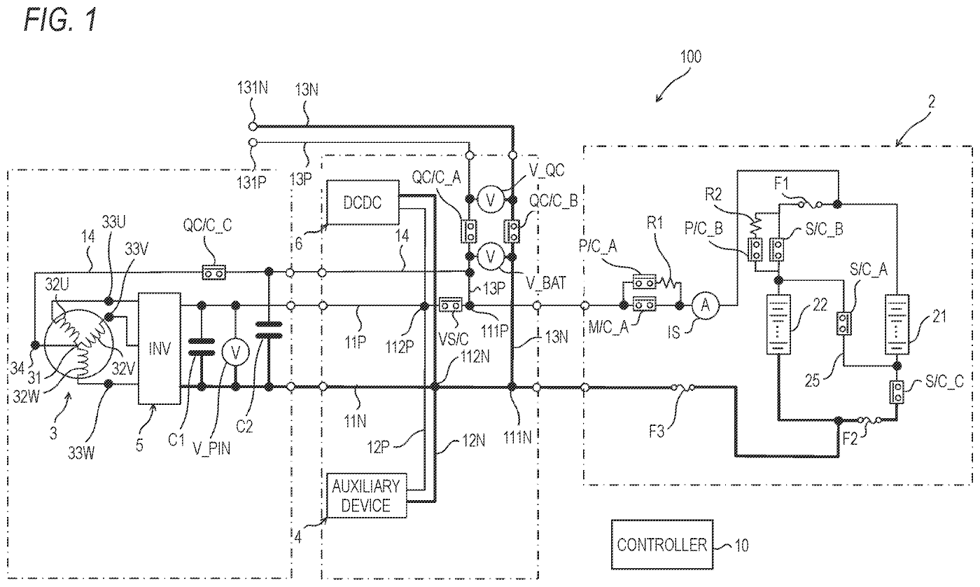

A vehicle 100 is an electric vehicle such as an electric automobile. By providing a configuration shown in FIG. 1, the vehicle 100 can not only quickly charge a battery 2 at charge voltages of 400 V and 800 V but also efficiently drive a three-phase motor 3 and an auxiliary device 4 at a base voltage of 800 V.

Specifically, as shown in FIG. 1, the vehicle 100 includes the battery 2, the three-phase motor 3, the auxiliary device 4, an inverter 5 (PDU), a DC-DC converter 6, electric power supply circuits 11P and 11N, auxiliary device drive circuits 12P and 12N. DC power supply circuits 13P and 13N, a branch circuit 14, and a controller 10.

As shown in FIGS. 1 to 3, the battery 2 includes a first power storage 21, a second power storage 22, first to sixth contactors S/C_A, S/C_B, S/C_C, M/C_A, P/C_A and P/C_B, first and second resistors R1 and R2, a current sensor IS, and first to third fuses F1 to F3.

The first power storage 21 and the second power storage 22 are battery modules which can perform charging and discharging of 400 V.

The fourth contactor M/C_A is provided at a positive electrode side end of the battery 2 and functions as a main switch which turns on and off connection to the outside (electric power supply circuit 11P) of the battery 2.

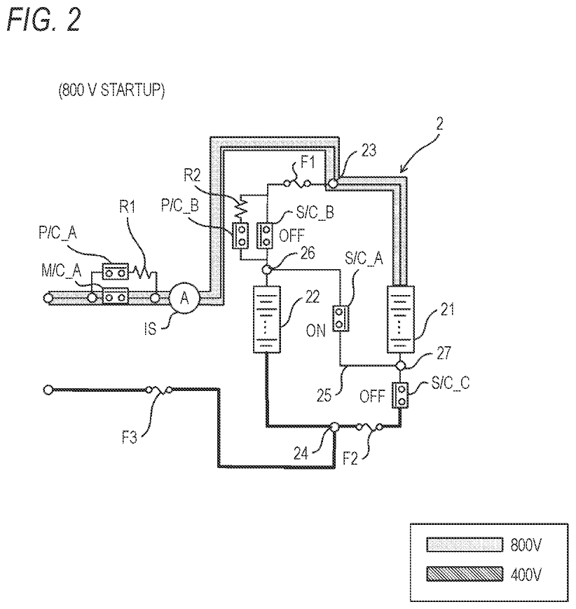

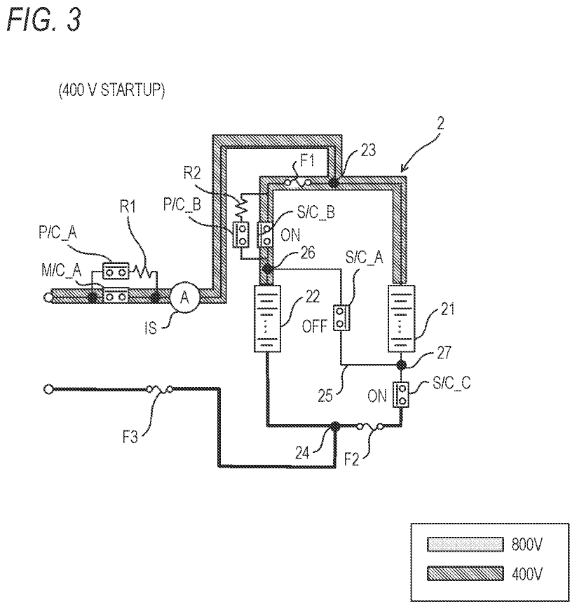

The first to third contactors S/C_A, S/C_B, and S/C_C switch a connection state between the first power storage 21 and the second power storage 22. For example, as shown in FIG. 2, when the first contactor S/C_A is turned on whereas the second contactor S/C_B and the third contactor S/C_C are turned off, the battery 2 is in a first voltage state (800 V startup) in which the first power storage 21 and the second power storage 22 are connected in series, so that the battery 2 can perform charging and discharging at 800 V. In addition, as shown in FIG. 3, when the first contactor S/C_A is turned off whereas the second contactor S/C_B and the third contactor S/C_C are turned on, the battery 2 is in a second voltage state (400 V startup) in which the first power storage 21 and the second power storage 22 are connected in parallel, so that the battery 2 can perform charging and discharging at 400 V. The term startup refers to a concept including driving during traveling of the vehicle 100 and charging during stopping of the vehicle 100.

Specifically, with reference to FIGS. 2 and 3, the battery 2 includes a positive node 23 that connects a positive terminal of the first power storage 21 and a positive terminal of the second power storage 22 in parallel, a negative node 24 that connects a negative terminal of the first power storage 21 and a negative terminal of the second power storage 22 in parallel, and a connection circuit 25 that connects the negative terminal of the first power storage 21 and the positive terminal of the second power storage 22. One end of the connection circuit 25 is connected to a circuit that connects the positive node 23 and the positive terminal of the second power storage 22 by a first connection portion 26, and the other end of the connection circuit 25 is connected to a circuit that connects the negative node 24 and the negative terminal of the first power storage 21 by a second connection portion 27. The first contactor S/C_A is provided in the connection circuit 25, the second contactor S/C_B is provided between the first connection portion 26 and the positive node 23, and the third contactor S/C_C is provided between the second connection portion 27 and the negative node 24.

The fifth contactor P/C_A and the first resistor R1 are disposed in series and are disposed in parallel with the fourth contactor M/C_A. In the first voltage state and the second voltage state, the fifth contactor P/C_A is turned on before the fourth contactor M/C_A is turned on, thereby protecting the fourth contactor M/C_A from an excessive inrush current.

The sixth contactor P/C_B and the second resistor R2 are disposed in series and are disposed in parallel with the second contactor S/C_B. In the second voltage state, the sixth contactor P/C_B is turned on before the second contactor S/C_B is turned on, thereby protecting the second contactor S/C_B from an excessive inrush current.

The current sensor IS is disposed between the fourth contactor M/C_A and the positive node 23 to measure a current.

The first fuse F1 is provided between the positive node 23 and the second contactor S/C_B, and the second fuse F2 is provided between the negative node 24 and the third contactor S/C_C. Therefore, when an overcurrent is generated inside the battery 2 due to an internal short circuit or the like, the first fuse F1 and/or the second fuse F2 is blown, so that the electrical connection inside the battery 2 is cut off, and the battery 2 is protected. The third fuse F3 is provided between the negative node 24 and the negative terminal of the battery 2. The third fuse F3 is preferably a fuse capable of intentionally interrupting a current in accordance with an electrical signal. The third fuse F3 is, for example, Pyro-Fuse.

Returning to FIG. 1, the three-phase motor 3 includes three-phase coils 32U, 32V, and 32W, one end side of each of which is connected to a neutral point 31, and is rotationally driven by electric power supplied from the battery 2 via the inverter 5. The three-phase motor 3 in the present embodiment includes a U-phase terminal 33U, a V-phase terminal 33V, and a W-phase terminal 33W, each of which is connected to the other end side of each of the coils 32U, 32V, and 32W, respectively, and a neutral point terminal 34 connected to the neutral point 31. The U-phase terminal 33U, the V-phase terminal 33V, and the W-phase terminal 33W are connected to the inverter 5, and the neutral point terminal 34 is connected to the branch circuit 14.

The inverter S converts DC electric power supplied from the battery 2 into three-phase AC electric power by switching a plurality of switching elements and rotationally drives the three-phase motor 3. When a DC (400 V) is supplied from the branch circuit 14 to the neutral point 31 of the three-phase motor 3, the inverter 5 can function as a booster circuit by switching the plurality of switching elements to boost the DC (to 800 V) using the coils 32U, 32V, and 32W. That is, the coils 32U, 32V, and 32W wound around a stator core are used as transformers.

The auxiliary device 4 is a high-voltage driven in-vehicle device which can be driven by DC electric power from the battery 2 and an external power supply. For example. the auxiliary device 4 includes an electric compressor or a heater for air-conditioning. The auxiliary device 4 is connected to the battery 2 via the auxiliary device drive circuits 12P and 12N, a seventh contactor VS/C, and the electric power supply circuits 11P and 11N, which will be described later. The auxiliary device 4 in the present embodiment is operated at the base voltage of 800 V.

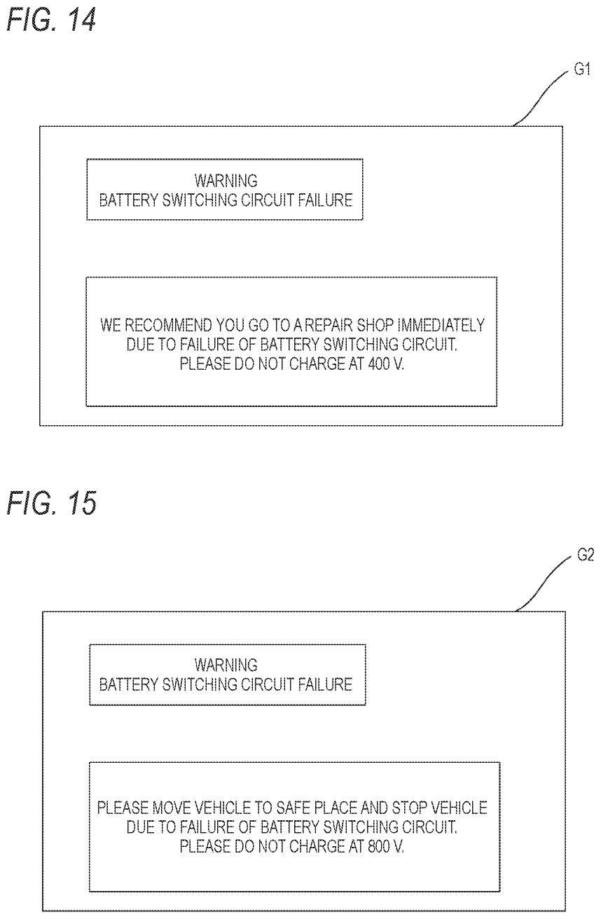

The DC-DC converter 6 steps down the DC electric power from the battery 2 and the external power supply to supply power to a low-voltage electric device 9 (see FIG. 14) The DC-DC converter 6 is provided with an ammeter (not shown).

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) at a side closer to the inverter 5 than the connection portions 111P and 111N. The electric power supply circuit 11P at a positive electrode side is provided with the seventh contactor VS/C which turns on and off a circuit between the connection portion 112P connected to the auxiliary device drive circuit 12P and the connection portion 111P connected to the DC power supply circuit 13P. A first voltage sensor V_PIN and a first smoothing capacitor C1 are provided in the electric power supply circuits 11P and 11N at a side close to the inverter 5, and a second smoothing capacitor C2 is further provided between the electric power supply circuit 11N at a negative electrode side and the branch circuit 14.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the connection portions 111P and 111N. The DC power supply circuits 13P and 13N are provided with an eighth contactor QC/C_A and a ninth contactor QC/C_B for turning on and off the respective circuits, a second voltage sensor V_BAT at a position closer to the connection portions 111P and 111N than the eighth contactor QC/C A and the ninth contactor QC/C_B, and a third voltage sensor V_QC at a position closer to the charge terminals 131P and 131N than the eighth contactor QC/C_A and the ninth contactor QC/C_B.

The branch circuit 14 is branched, in the DC power supply circuit 13P at the positive electrode side, at a position closer to the connection portion 111P than the eighth contactor QC/C_A and the second voltage sensor V_BAT and is connected to the neutral point 31 (neutral point terminal 34) of the three-phase motor 3. An intermediate portion of the branch circuit 14 is provided with a tenth contactor QC/C_C for turning on and off the circuit.

The controller 10 is, for example, a vehicle ECU and controls driving and charging of a power storage system 1. More specifically, the controller 10 performs ON/OFF control of the first to tenth contactors S/C_A, S/C_B, S/C_C, M/C_A, P/C_A, P/C_B, VS/C, QC/C_A, QC/C_B, and QC/C_C, sticking detection (welding detection) of these contactors, and control of the DC-DC converter 6 and the inverter 5.

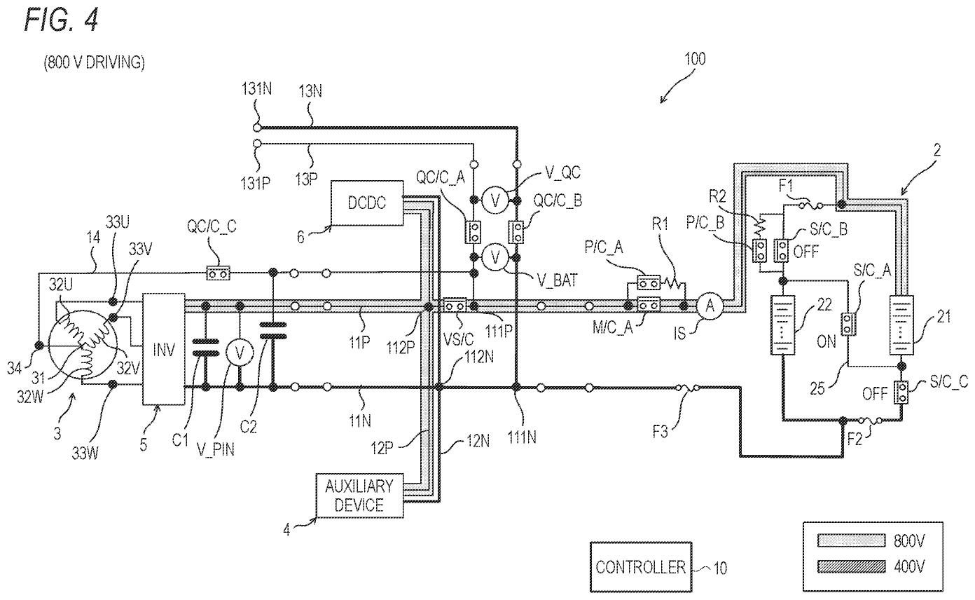

Next, an operation of the vehicle 100 will be described with reference to FIGS. 4 to 9.

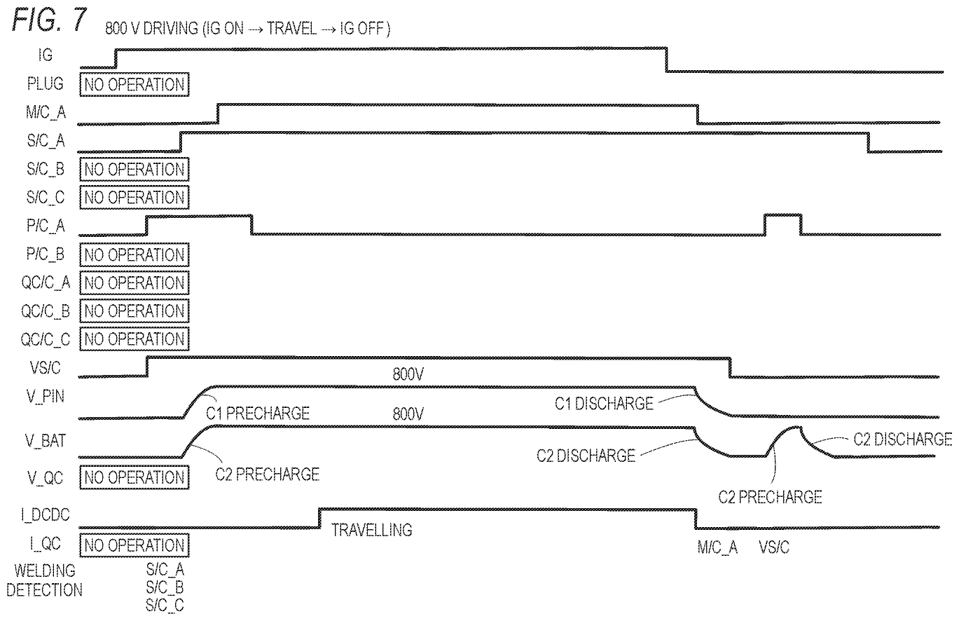

FIG. 4 shows a current flow during traveling (800 V driving) of the vehicle 100, and FIG. 7 shows an operation sequence during traveling (800 V driving) of the vehicle 100.

When an ignition switch IG of the vehicle 100 is turned on, the controller 10 first turns on the fifth contactor P/C_A and the seventh contactor VS/C and checks detected voltage values of the first voltage sensor V_PIN and the second voltage sensor V_BAT. When the detected voltage values of the first voltage sensor V_PIN and the second voltage sensor V_BAT increase, the controller 10 determines that any one of the first to third contactors S/C_A, S/C_B, and S/C_C is stuck (welded) in an ON state, and performs abnormality control such as abnormality notification.

When the controller 10 determines that the first to third contactors S/C_A, S/C_B, and S/C_C are not welded, the controller 10 turns on the first contactor S/C_A and connects the circuit in the battery 2 in the first voltage state (800 V). When the circuit in the battery 2 is connected in the first voltage state (800 V), the first smoothing capacitor C1 and the second smoothing capacitor C2 are pre-charged and the detected voltage values of the first voltage sensor V_PIN and the second voltage sensor V_BAT gradually increase.

The controller 10 turns on the fourth contactor M/C_A to activate the battery 2 in the first voltage state (800 V) at a timing when the pre-charging of the first smoothing capacitor C1 and the second smoothing capacitor C2 is completed, and then turns off the fifth contactor P/C_A. Accordingly, travel of the vehicle 100 is enabled. At this time, the auxiliary device 4 is connected to the electric power supply circuits 11P and 11N via the auxiliary device drive circuits 12P and 12N and is driven by a first voltage (800 V) supplied from the battery 2.

On the other hand, when the ignition switch IG is turned off, the controller 10 first turns off the fourth contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the controller 10 determines that the fourth contactor M/C_A is welded, and performs abnormality control such as abnormality notification.

When the controller 10 determines that the fourth contactor M/C_A is not welded. the controller 10 turns off the seventh contactor VS/C at a timing when the discharging of the first and second smoothing capacitors C1 and C2 is completed. The controller 10 then turns on the fifth contactor P/C_A and checks the detected voltage value of the first voltage sensor V_PIN. When the detected voltage value of the first voltage sensor V_PIN increases, the controller 10 determines that the seventh contactor VS/C is welded and performs abnormality control such as abnormality notification.

When the controller 10 determines that the seventh contactor VS/C is not welded, the controller 10 turns off the fifth contactor P/C_A and the first contactor S/C_A and ends the operation sequence during traveling.

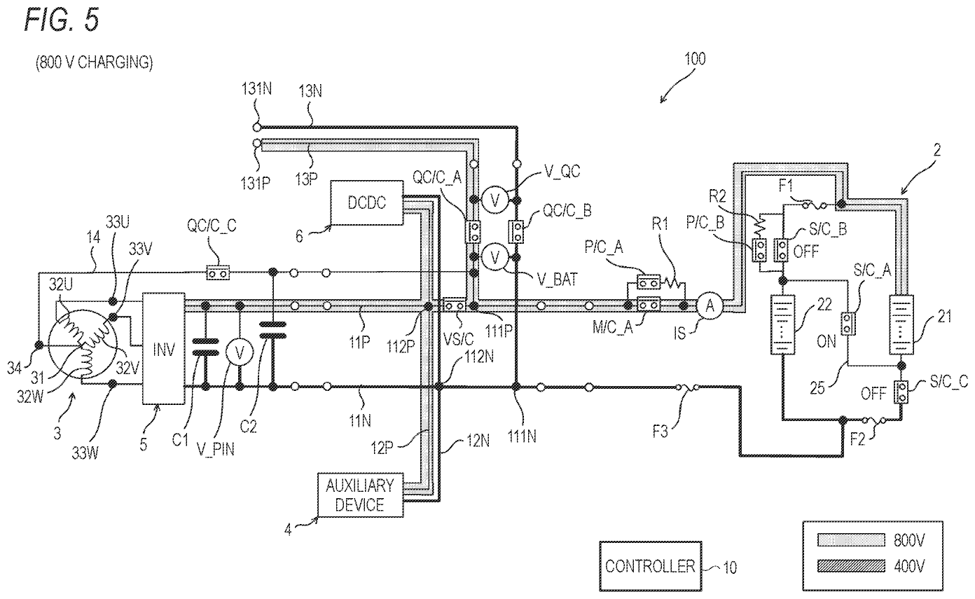

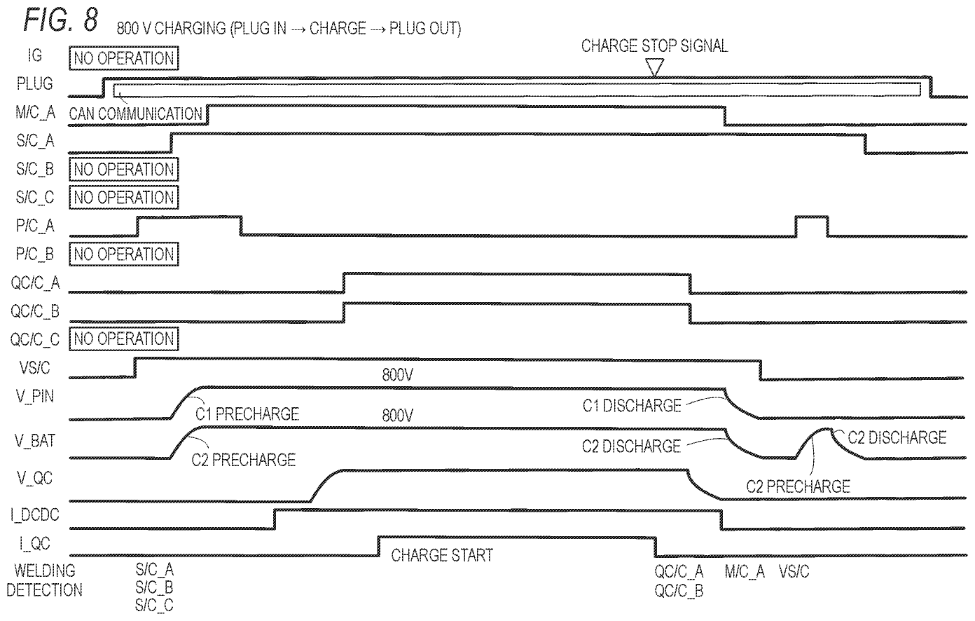

FIG. 5 shows a current flow during charging the vehicle 100 (800 V charging) at the first voltage, and FIG. 8 shows an operation sequence during charging the vehicle 100 (800 V charging) at the first voltage.

When a charge plug is connected to the charge terminals 131P and 131N, the controller 10 performs CAN communication with charging equipment to recognize a charge voltage. When the charge voltage is the first voltage (800 V), the controller 10 first turns on the fifth contactor P/C_A and the seventh contactor VS/C and checks the detected voltage values of the first voltage sensor V_PIN and the second voltage sensor V_BAT. When the detected voltage values of the first voltage sensor V_PIN and the second voltage sensor V_BAT increase, the controller 10 determines that any one of the first to third contactors S/C_A, S/C_B, and S/C_C is welded and performs abnormality control such as abnormality notification.

When the controller 10 determines that the first to third contactors S/C_A, S/C_B, and S/C_C are not welded, the controller 10 turns on the first contactor S/C_A and connects the circuit in the battery 2 in the first voltage state (800 V). When the circuit in the battery 2 is connected in the first voltage state (800 V), the first smoothing capacitor C1 and the second smoothing capacitor C2 are pre-charged and the detected voltage values of the first voltage sensor V_PIN and the second voltage sensor V_BAT gradually increase.

The controller 10 turns on the fourth contactor M/C_A to activate the battery 2 in the first voltage state (800 V) at a timing when the pre-charging of the first smoothing capacitor C1 and the second smoothing capacitor C2 is completed, and then turns off the fifth contactor P/C_A. Accordingly, the battery 2 is in a state in which charging with the first voltage (800 V) can be started.

Thereafter, the controller 10 turns on the eighth contactor QC/C_A and the ninth contactor QC/C_B to start charging the battery 2 with the first voltage (800 V). At this time. the auxiliary device 4 is connected to the DC power supply circuits 13P and 13N via the auxiliary device drive circuits 12P and 12N and the seventh contactor VS/C and is driven by the first voltage (800 V) supplied from the charging equipment.

On the other hand, when the controller 10 determines that a charge stop signal is received, the controller 10 turns off the eighth contactor QC/C_A and the ninth contactor QC/C_B and checks a detected voltage value of the third voltage sensor V_QC. When the detected voltage value of the third voltage sensor V QC does not decrease, the controller 10 determines that the eighth contactor QC/C_A and the ninth contactor QC/C_B are welded and performs abnormality control such as abnormality notification.

When the controller 10 determines that the eighth contactor QC/C_A and the ninth contactor QC/C_B are not welded, the controller 10 turns off the fourth contactor M/C A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the controller 10 determines that the fourth contactor M/C_A is welded, and performs abnormality control such as abnormality notification.

When the controller 10 determines that the fourth contactor M/C_A is not welded, the controller 10 turns off the seventh contactor VS/C at a timing when the discharging of the first and second smoothing capacitors C1 and C2 is completed. The controller 10 then turns on the fifth contactor P/C_A and checks the detected voltage value of the first voltage sensor V_PIN. When the detected voltage value of the first voltage sensor V_PIN increases, the controller 10 determines that the seventh contactor VS/C is welded and performs abnormality control such as abnormality notification.

When the controller 10 determines that the seventh contactor VS/C is not welded, the controller 10 turns off the fifth contactor P/C_A and the first contactor S/C_A and ends the operation sequence during charging at the first voltage (800 V).

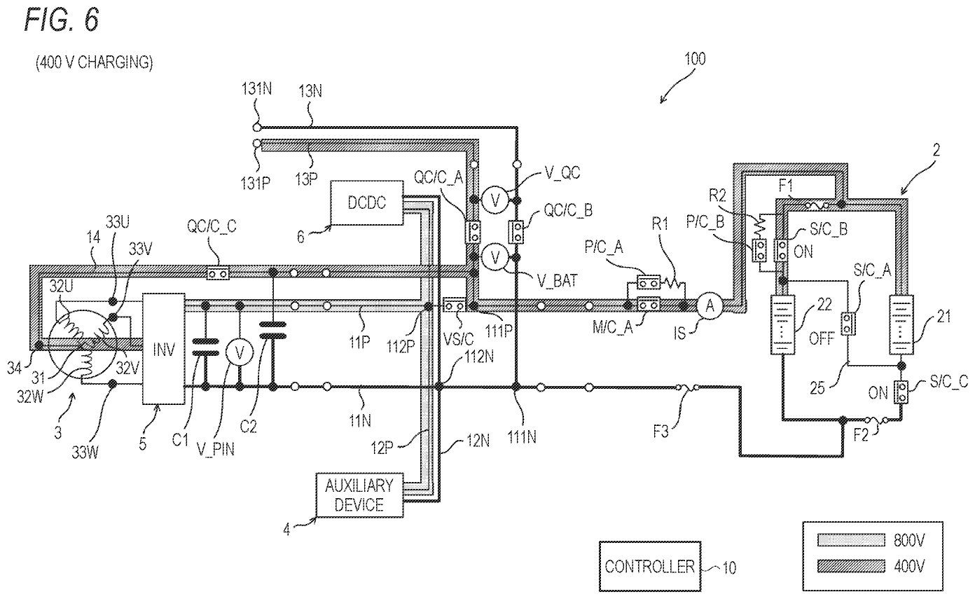

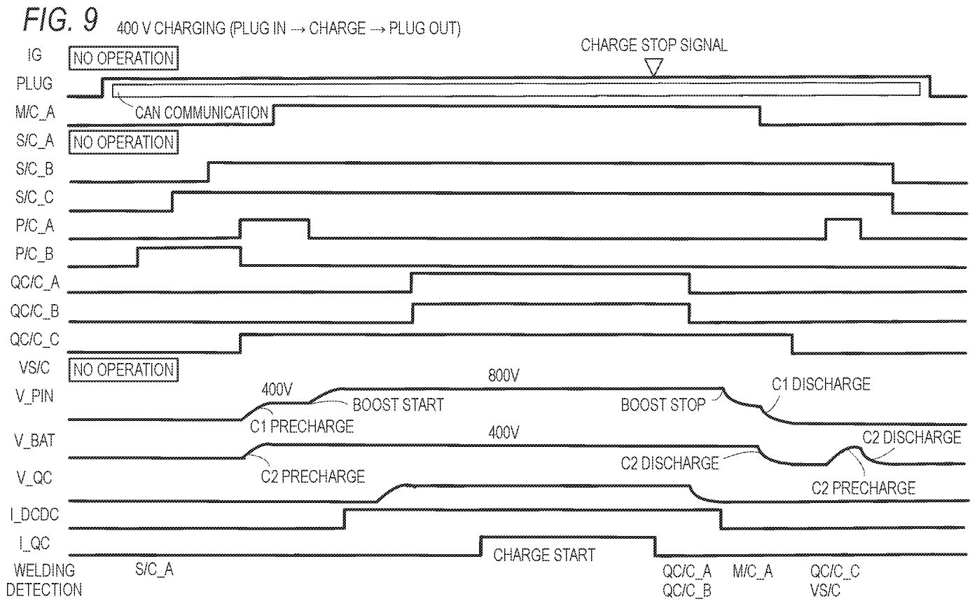

FIG. 6 shows a current flow during charging the vehicle 100 (400 V charging) at a second voltage, and FIG. 9 shows an operation sequence during charging the vehicle 100 (400 V charging) at the second voltage.

When a charge plug is connected to the charge terminals 131P and 131N, the controller 10 performs CAN communication with charging equipment to recognize a charge voltage. When the charge voltage is the second voltage (400 V), the controller 10 first turns on the sixth contactor P/C_B and checks a change in a voltage sensor (CVS) (not shown) mounted on the first power storage 21. When the voltage sensor (CVS) changes, the controller 10 determines that the first contactor S/C_A is welded and performs abnormality control such as abnormality notification.

When the controller 10 determines that the first contactor S/C_A is not welded, the controller 10 turns on the third contactor S/C_C, then turns on the second contactor S/C_B and connects the circuit in the battery 2 in the second voltage state (400 V). Thereafter, the controller 10 turns off the sixth contactor P/C_B, turns on the fifth contactor P/C_A and the tenth contactor QC/C_C to enable the booster circuit implemented by the three-phase motor 3 and the inverter 5. Next, the controller 10 turns on the fourth contactor M/C_A to activate the battery 2 in the second voltage state (400 V) and then turns off the fifth contactor P/C_A. Accordingly, the battery 2 is in a state in which charging with the second voltage (400 V) can be started.

Thereafter, the controller 10 turns on the eighth contactor QC/C_A and the ninth contactor QC/C_B to start charging the battery 2 with the second voltage (400 V). At this time, the three-phase motor 3 and the inverter 5 connected to the DC power supply circuits 13P and 13N via the branch circuit 14 boost the second voltage (400 V) supplied from the charging equipment to the first voltage (800 V) to drive the auxiliary device 4.

On the other hand, when the controller 10 determines that a charge stop signal is received, the controller 10 turns off the eighth contactor QC/C_A and the ninth contactor QC/C_B and checks a detected voltage value of the third voltage sensor V_QC. When the detected voltage value of the third voltage sensor V_QC does not decrease, the controller 10 determines that the eighth contactor QC/C_A and the ninth contactor QC/C_B are welded and performs abnormality control such as abnormality notification.

When the controller 10 determines that the eighth contactor QC/C_A and the ninth contactor QC/C_B are not welded, the controller 10 stops the boosting performed by the three-phase motor 3 and the inverter 5, then turns off the fourth contactor M/C_A and checks the detected voltage values of the first voltage sensor V_PIN and the second voltage sensor V_BAT. When the detected voltage values of the first voltage sensor V_PIN and the second voltage sensor V_BAT do not decrease due to discharging of the first and second smoothing capacitors C1 and C2, the controller 10 determines that the fourth contactor M/C_A is welded. and performs abnormality control such as abnormality notification.

When the controller 10 determines that the fourth contactor M/C_A is not welded. the controller 10 turns off the tenth contactor QC/C_C at a timing when the discharging of the first and second smoothing capacitors C1 and C2 is completed. The controller 10 then turns on the fifth contactor P/C_A and checks the detected voltage value of the first voltage sensor V_PIN. When the detected voltage value of the first voltage sensor V_PIN increases, the controller 10 determines that any one of the tenth contactor QC/C_C and the seventh contactor VS/C is welded and performs abnormality control such as abnormality notification.

When the controller 10 determines that there is no welding, the controller 10 turns off the fifth contactor P/C_A, the second contactor S/C_B, and the third contactor S/C_C, and ends the operation sequence during charging at the second voltage (400 V).

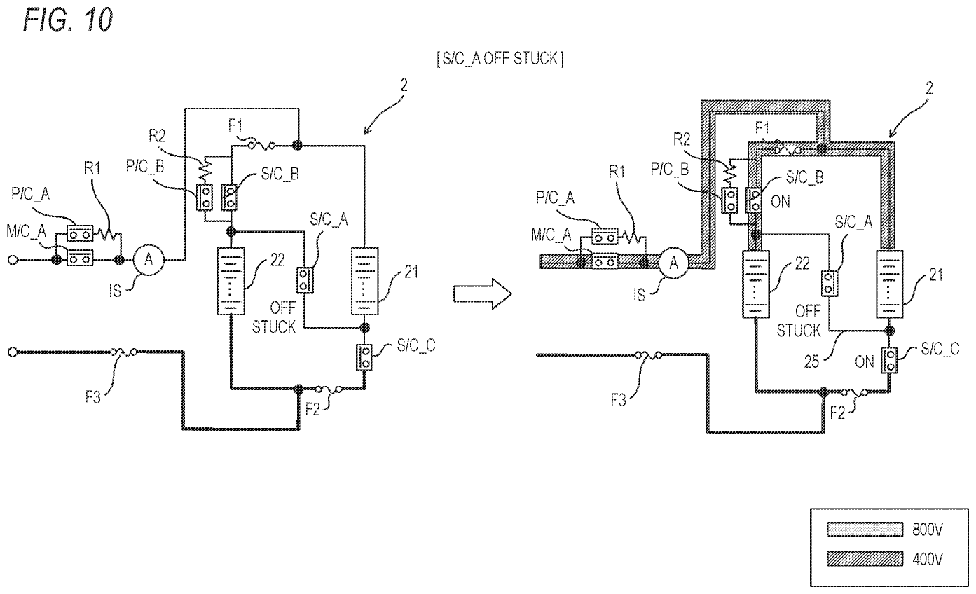

Next, the abnormality control executed by the controller 10 when the first contactor S/C_A is stuck in the OFF state, the second contactor S/C_B or the third contactor S/C_C is stuck in the OFF state, the first fuse F1 and/or the second fuse F2 is blown, the first contactor S/C_A is stuck in the ON state, and the second contactor S/C_B or the third contactor S/C_C is stuck in the ON state will be described with reference to FIGS. 10 to 15.

As shown in FIG. 10, when the first contactor S/C_A is stuck in the OFF state, the controller 10 turns on the second contactor S/C_B and the third contactor S/C_C to set the battery 2 to the second voltage state (400 V startup), and drives the three-phase motor 3 in the second voltage state. The drive of the three-phase motor 3 in the second voltage state is for retracting the vehicle 100 (limp home), and it is desirable to display a warning screen G2 as shown in FIG. 15 for a driver. For example, the warning screen G2 includes warning messages such as “WARNING BATTERY SWITCHING CIRCUIT FAILURE”, “Please move the vehicle to a safe place and stop the vehicle due to the failure of the battery switching circuit. Also, please do not charge at 800 V”.

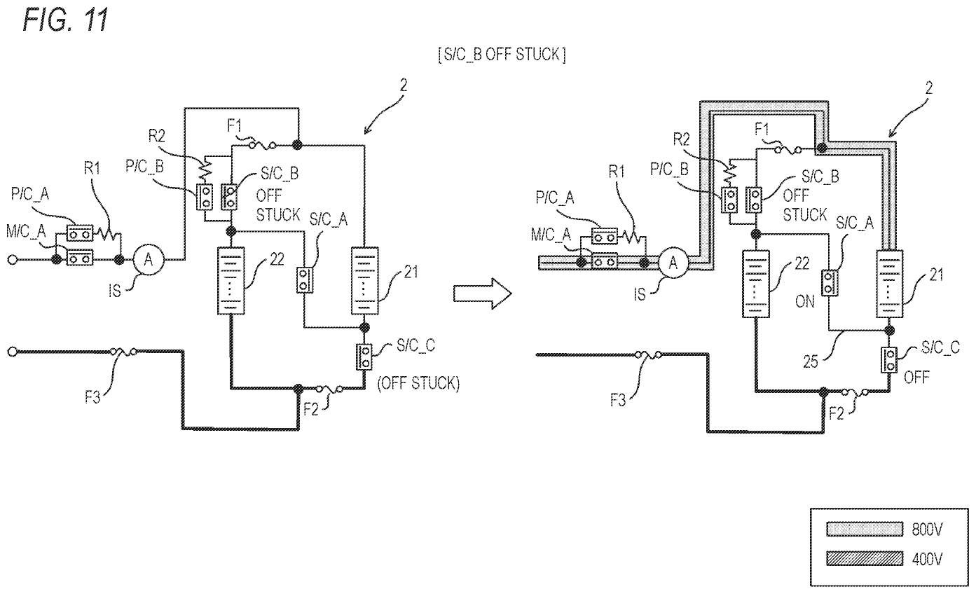

As shown in FIG. 11, when the second contactor S/C_B is stuck in the OFF state, the controller 10 turns off the third contactor S/C_C and turns on the first contactor S/C_A to set the battery 2 to the first voltage state (800 V startup), and drives the three-phase motor 3 in the first voltage state. In this case, although the vehicle 100 can normally travel in the first voltage state, it is desirable to display a warning screen G1 as shown in FIG. 14 for the driver. For example, the warning screen G1 includes warning messages such as “WARNING BATTERY SWITCHING CIRCUIT FAILURE” and “We recommend you go to a repair shop due to the failure of the battery switching circuit. Also, please do not charge at 400 V”. In a case where the third contactor S/C_C is stuck in the OFF state or the second contactor S/C_B and the third contactor S/C_C are stuck in the OFF state, when the first fuse F1 and/or the second fuse F2 is blown, the controller 10 performs the abnormality control similar to the case where the second contactor S/C_B is stuck in the OFF state.

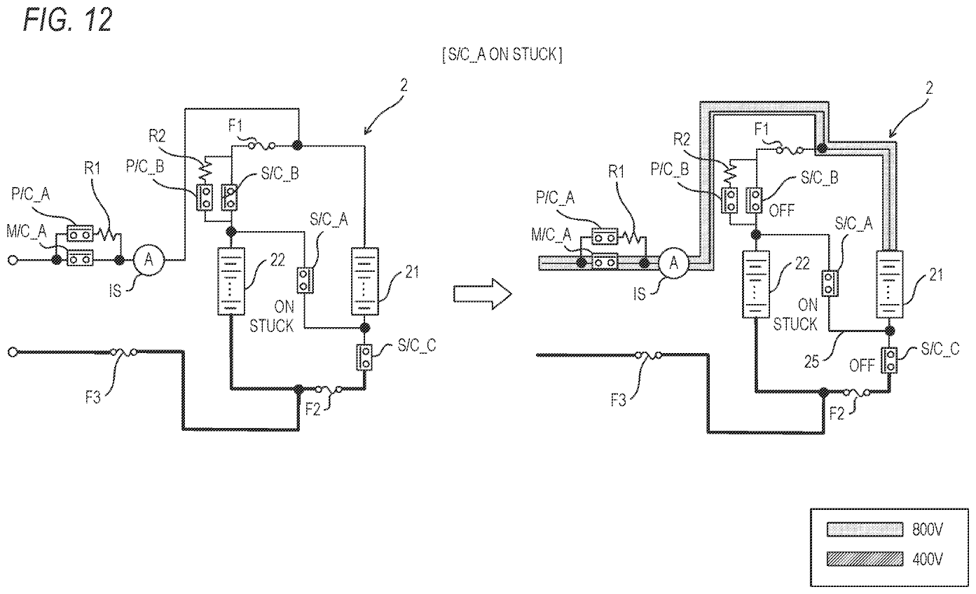

As shown in FIG. 12, when the first contactor S/C_A is stuck in the ON state, the controller 10 turns off the second contactor S/C_B and the third contactor S/C_C to set the battery 2 to the first voltage state (800 V startup), and drives the three-phase motor 3 in the first voltage state. In this case, although the vehicle 100 can normally travel in the first voltage state, it is desirable to display a warning screen G1 as shown in FIG. 14 for the driver.

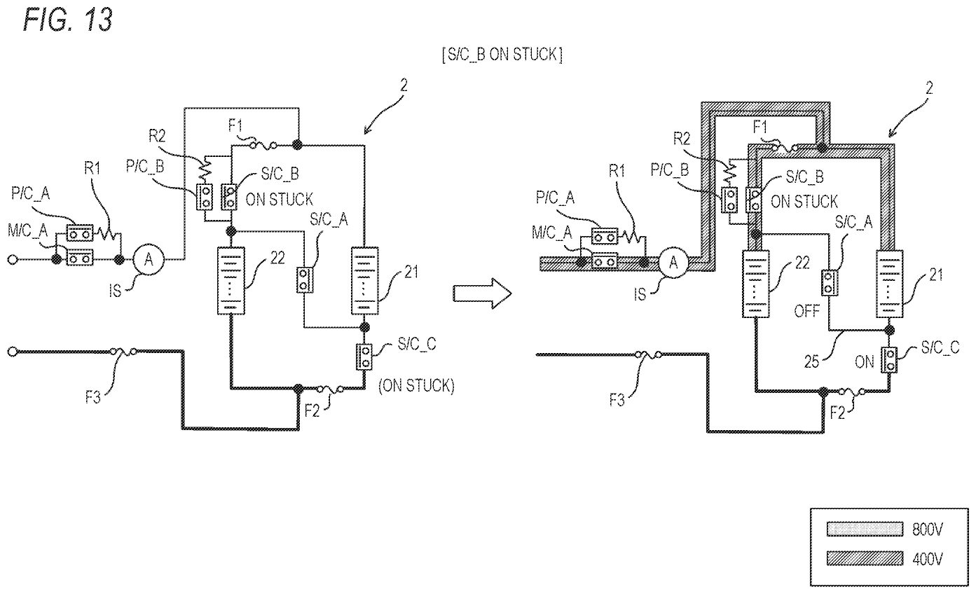

As shown in FIG. 13, when the second contactor S/C_B is stuck in the ON state, the controller 10 turns off the first contactor S/C_C and turns on the third contactor S/C_A to set the battery 2 to the second voltage state (400 V startup), and drives the three-phase motor 3 in the second voltage state. The drive of the three-phase motor 3 in the second voltage state is for retracting the vehicle 100 (limp home), and it is desirable to display a warning screen G2 as shown in FIG. 15 for a driver. In a case where the third contactor S/C_C is stuck in the ON state or the second contactor S/C_B and the third contactor S/C_C are stuck in the ON state, the controller 10 performs the abnormality control similar to the case where the second contactor S/C_B is stuck in the ON state.

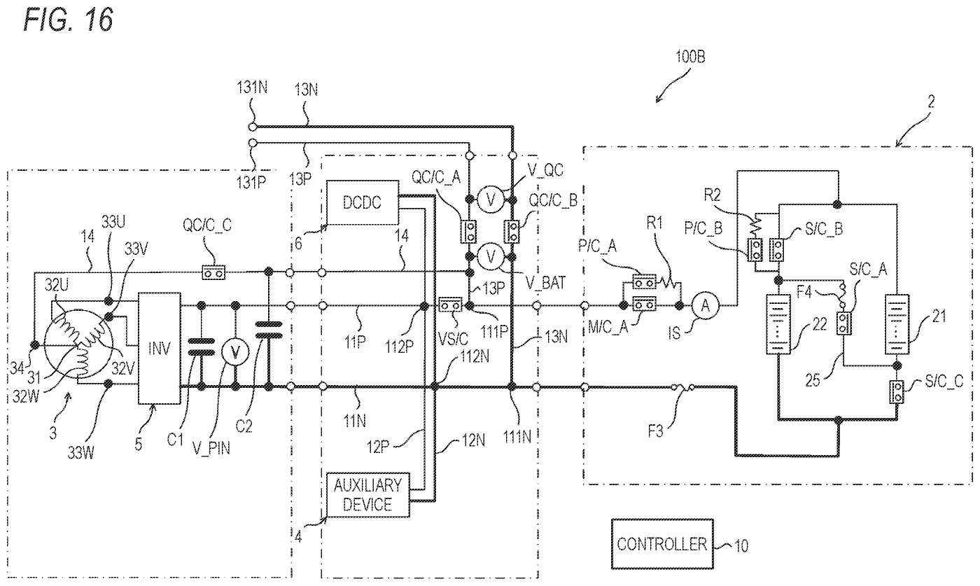

Next, configurations of vehicles 100B to 100D according to modifications will be described with reference to FIGS. 16 to 18. Here, the same reference numerals as in the above embodiment are used for the same configurations as in the above embodiment, and the description of the above embodiment may be incorporated.

FIG. 16 shows a configuration of a vehicle 100B according to a first modification.

As shown in FIG. 16, the vehicle 100B of the first modification has a basic configuration similar to that of the vehicle 100 of the above embodiment, but is different from the vehicle 100 of the above embodiment in that a fourth fuse F4 provided in the connection circuit 25 is provided instead of the first fuse F1 and the second fuse F2 of the above embodiment. When an overcurrent is generated inside the battery 2 due to an internal short circuit or the like, the fourth fuse F4 is blown, so that the electrical connection inside the battery 2 is cut off, and the battery 2 is protected. According to the vehicle 100B of the first modification, when the fourth fuse F4 is blown, the second contactor S/C_B and the third contactor S/C_C are turned on to set the battery 2 to the second voltage state (400 V startup). and the three-phase motor 3 can be driven in the second voltage state. In addition, when the first contactor S/C_A is stuck in the OFF state, the second contactor S/C_B and/or the third contactor S/C_C is stuck in the OFF state, the first contactor S/C_A is stuck in the ON state. and the second contactor S/C_B and/or the third contactor S/C_C is stuck in the ON state, it is possible to drive the three-phase motor 3 in either the first voltage state or the second voltage state by the abnormality control similar to the above embodiment.

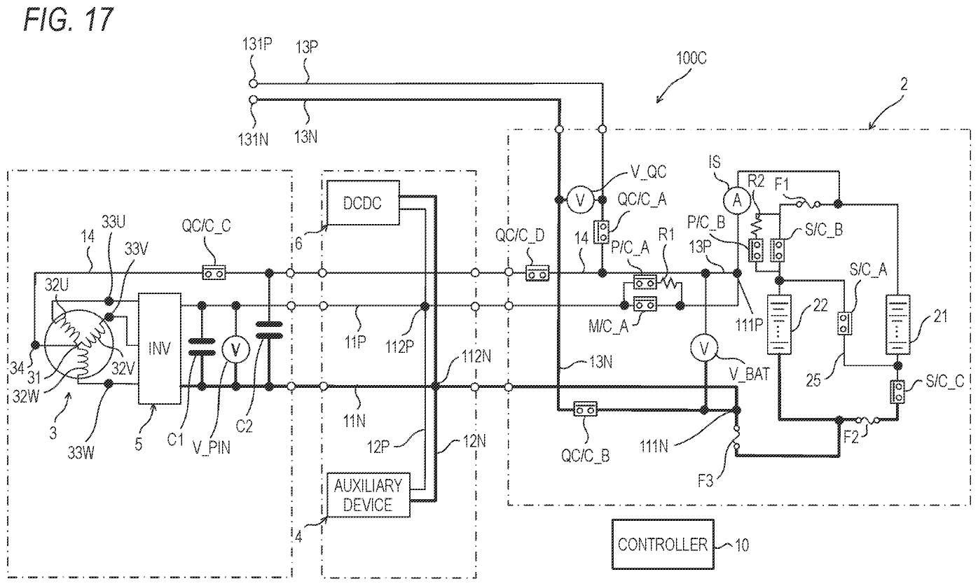

FIG. 17 shows a configuration of a vehicle 100C according to a second modification.

In the vehicle 100 of the above embodiment, the eighth contactor QC/C_A which is a main switch for charging is connected in series to the fourth contactor M/C_A which is the main switch of the battery 2. However, in the vehicle 100C according to the second modification, as shown in FIG. 17, the eighth contactor QC/C_A is connected in parallel to the fourth contactor M/C_A.

The vehicle 100C according to the second modification can also achieve the same effects as those of the vehicle 100 of the above embodiment. In addition, in the vehicle 100C according to the second modification, during charging at the second voltage (400 V), the battery 2 charged with the second voltage (400 V) can be separated, by the fourth contactor M/C_A, from the first voltage (800 V) boosted by the three-phase motor 3 and the inverter 5. and thus no switch component corresponding to the seventh contactor VS/C in the above embodiment is required.

In the vehicle 100C according to the second modification, it is assumed that the eighth contactor QC/C_A, the ninth contactor QC/C_B, the second voltage sensor V_BAT. and the third voltage sensor V_QC are disposed in the battery 2 and the branch circuit 14 is drawn out from the battery 2. Therefore, an eleventh contactor QC/C_D is provided in the battery 2 at a position closer to the inverter 5 than a position in the vicinity of the branch of the branch circuit 14 in order to cut off connection with the outside of the battery when an abnormality occurs.

According to the vehicle 100C of the second modification, when the first contactor S/C_A is stuck in the OFF state, the second contactor S/C_B and/or the third contactor S/C_C is stuck in the OFF state, the first fuse F1 and/or the second fuse F2 is blown, the first contactor S/C_A is stuck in the ON state, and the second contactor S/C_B and/or the third contactor S/C_C is stuck in the ON state, it is possible to drive the three-phase motor 3 in either the first voltage state or the second voltage state by the abnormality control similar to the above embodiment.

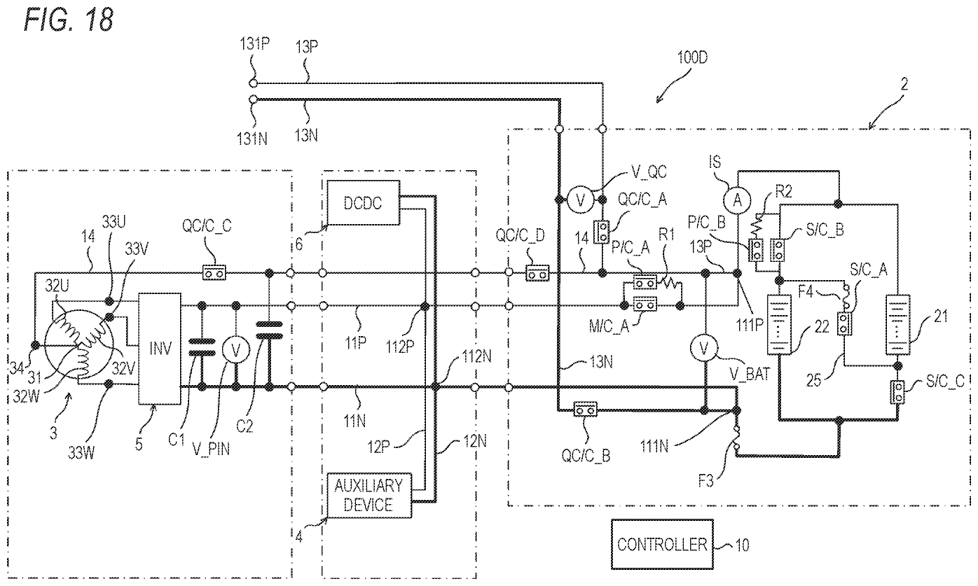

FIG. 18 shows a configuration of a vehicle 100D according to a third modification.

As shown in FIG. 18, the vehicle 100D according to the third modification has a basic configuration similar to that of the vehicle 100C according to the second modification, but is different from the vehicle 100C according to the second modification in that a fourth fuse F4 provided in the connection circuit 25 is provided instead of the first fuse F1 and the second fuse F2 of the second modification. According to the vehicle 100D of the third modification, when the fourth fuse F4 is blown, the second contactor S/C_B and the third contactor S/C_C are turned on to set the battery 2 to the second voltage state (400 V startup). and the three-phase motor 3 can be driven in the second voltage state. In addition, when the first contactor S/C_A is stuck in the OFF state, the second contactor S/C_B and/or the third contactor S/C_C is stuck in the OFF state, the first contactor S/C_A is stuck in the ON state. and the second contactor S/C_B and/or the third contactor S/C_C is stuck in the ON state, it is possible to drive the three-phase motor 3 in either the first voltage state or the second voltage state by the abnormality control similar to the above embodiment.

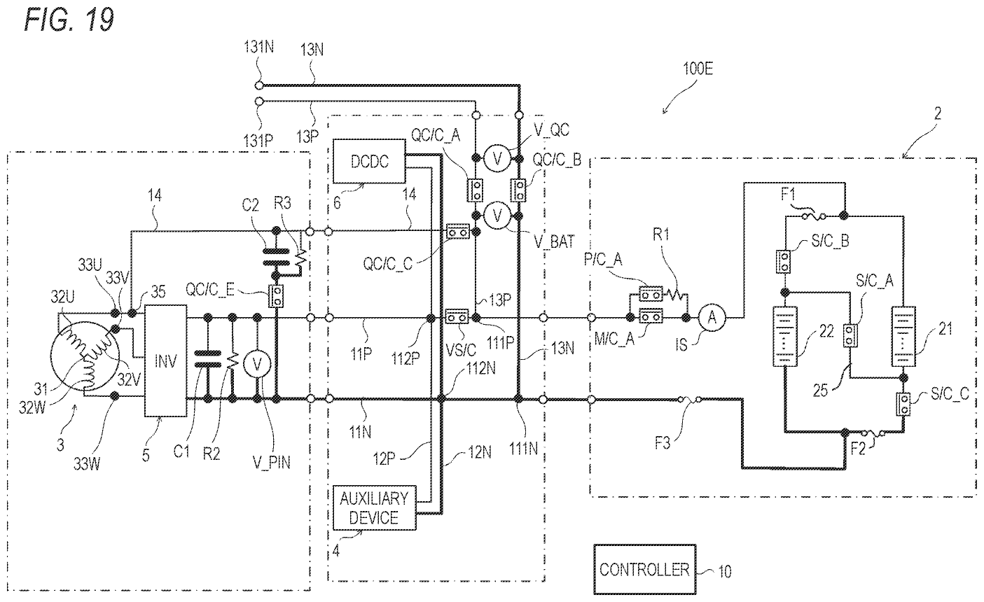

FIG. 19 shows a configuration of a vehicle 100E according to a fourth modification.

As shown in FIG. 19, the vehicle 100E according to the fourth modification has a basic configuration similar to that of the vehicle 100 of the above embodiment However, there is a difference in that the branch circuit 14 is connected to the neutral point 31 in the vehicle 100 of the above embodiment, whereas the branch circuit 14 is connected to a coil of any one phase among the coils 32U, 32V, and 32W in the vehicle 100E according to the fourth modification. In the present modification, among the three-phase coils 32U, 32V, 32W, the coil 32U is connected to the branch circuit 14 via a connection terminal 35 located between the U-phase terminal 33U and the inverter 5. Accordingly, when the DC (400 V) is supplied from the branch circuit 14 to the connection terminal 35 during charging at the second voltage (400 V charging), the inverter 5 can cause the three-phase motor 3 to function as a booster circuit that boosts (800 V) the DC using the other two phase coils (coils 32V and 32W in the present embodiment) by switching the plurality of switching elements.

According to the vehicle 100E of the fourth modification, when the first contactor S/C_A is stuck in the OFF state, the second contactor S/C_B and/or the third contactor S/C_C is stuck in the OFF state, the first fuse F1 and/or the second fuse F2 is blown, the first contactor S/C_A is stuck in the ON state, and the second contactor S/C_B and/or the third contactor S/C_C is stuck in the ON state, it is possible to drive the three-phase motor 3 in either the first voltage state or the second voltage state by the abnormality control similar to the above embodiment.

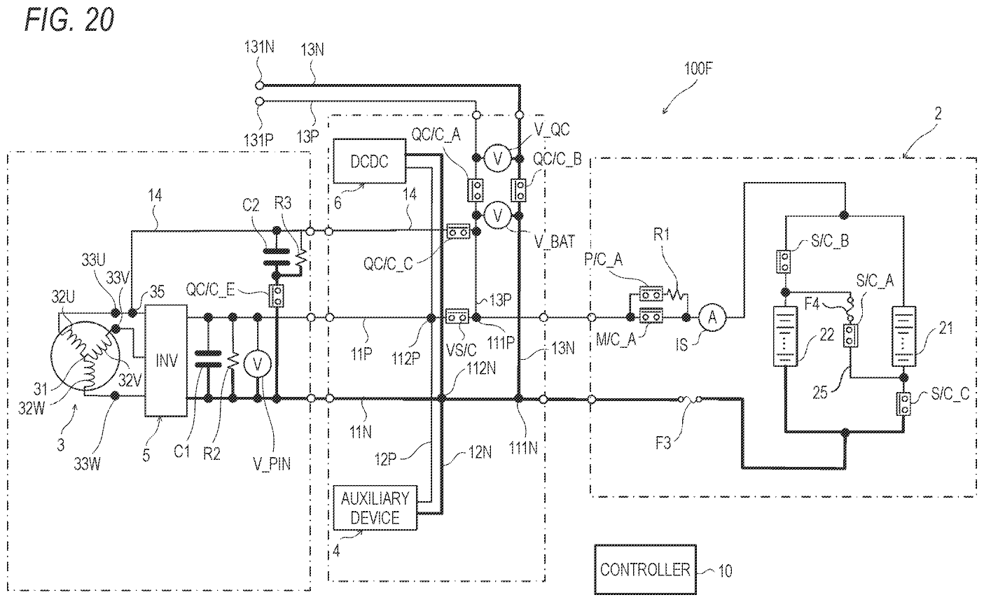

FIG. 20 shows a configuration of a vehicle 100F according to a fifth modification.

As shown in FIG. 20, the vehicle 100F according to the fifth modification has a basic configuration similar to that of the vehicle 100E according to the fourth modification. but is different from the vehicle 100E according to the fourth modification in that a fourth fuse F4 provided in the connection circuit 25 is provided instead of the first fuse F1 and the second fuse F2 of the fourth modification. When an overcurrent is generated inside the battery 2 due to an internal short circuit or the like, the fourth fuse F4 is blown, so that the electrical connection inside the battery 2 is cut off, and the battery 2 is protected. According to the vehicle 100F of the fifth modification, when the fourth fuse F4 is blown, the second contactor S/C_B and the third contactor S/C_C are turned on to set the battery 2 to the second voltage state (400 V startup), and the three-phase motor 3 can be driven in the second voltage state. In addition, when the first contactor S/C_A is stuck in the OFF state, the second contactor S/C_B and/or the third contactor S/C_C is stuck in the OFF state, the first contactor S/C_A is stuck in the ON state, and the second contactor S/C_B and/or the third contactor S/C_C is stuck in the ON state, it is possible to drive the three-phase motor 3 in either the first voltage state or the second voltage state by the abnormality control similar to the above embodiment.

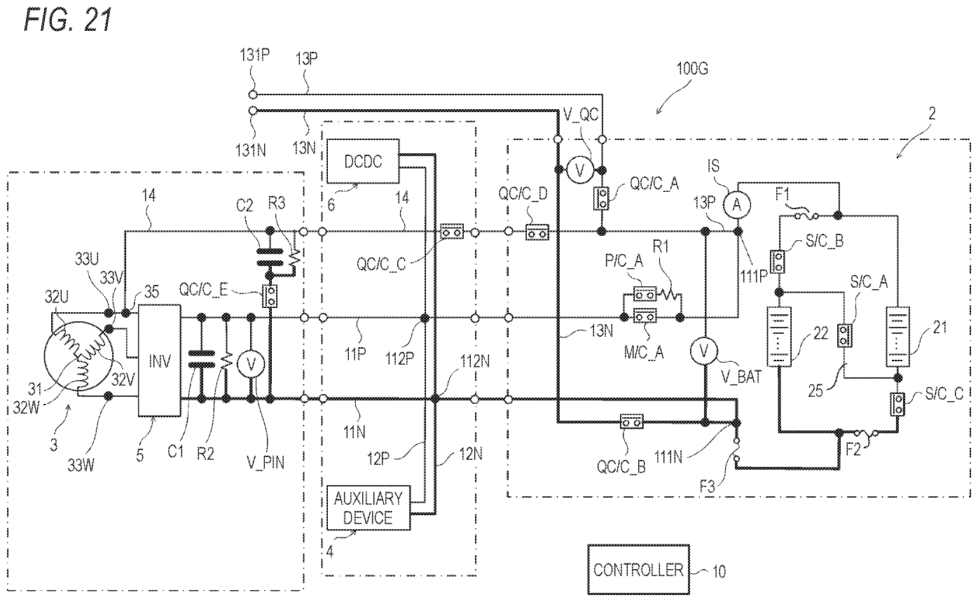

FIG. 21 shows a configuration of a vehicle 100G according to a sixth modification.

In the vehicle 100E according to the fourth modification, the eighth contactor QC/C_A which is a main switch for charging is connected in series to the fourth contactor M/C_A which is the main switch of the battery 2. However, in the vehicle 100G according to the sixth modification, as shown in FIG. 21, the eighth contactor QC/C_A is connected in parallel to the fourth contactor M/C_A.

The vehicle 100G according to the sixth modification can also achieve the same effects as those of the vehicle 100E according to the fourth modification. In addition, in the vehicle 100G according to the sixth modification, during charging at the second voltage (400 V), the battery 2 charged with the second voltage (400 V) can be separated, by the fourth contactor M/C_A, from the first voltage (800 V) boosted by the three-phase motor 3 and the inverter 5, and thus no switch component corresponding to the seventh contactor VS/C in the above embodiment is required.

In the vehicle 100G according to the sixth modification, it is assumed that the eighth contactor QC/C_A, the ninth contactor QC/C_B, the second voltage sensor V_BAT, and the third voltage sensor V_QC are disposed in the battery 2 and the branch circuit 14 is drawn out from the battery 2. Therefore, an eleventh contactor QC/C_D is provided in the battery 2 at a position closer to the inverter 5 than a position in the vicinity of the branch of the branch circuit 14 in order to cut off connection with the outside of the battery when an abnormality occurs.

According to the vehicle 100G of the sixth modification, when the first contactor S/C_A is stuck in the OFF state, the second contactor S/C_B and/or the third contactor S/C_C is stuck in the OFF state, the first fuse F1 and/or the second fuse F2 is blown, the first contactor S/C_A is stuck in the ON state, and the second contactor S/C_B and/or the third contactor S/C_C is stuck in the ON state, it is possible to drive the three-phase motor 3 in either the first voltage state or the second voltage state by the abnormality control similar to the above embodiment.

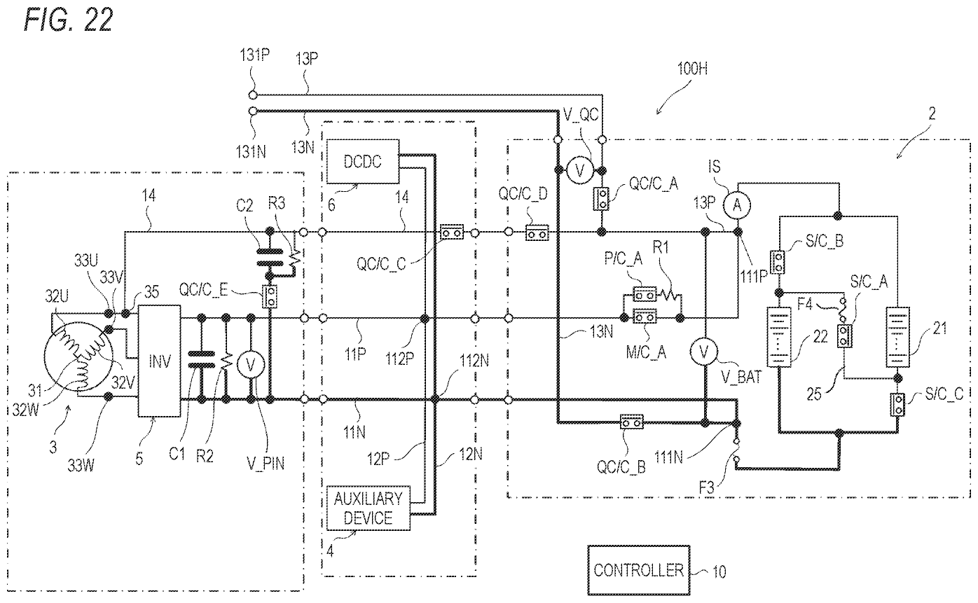

FIG. 22 shows a configuration of a vehicle 100H according to a seventh modification.

As shown in FIG. 22, the vehicle 100H according to the seventh modification has a basic configuration similar to that of the vehicle 100G according to the sixth modification, but is different from the vehicle 100G according to the sixth modification in that a fourth fuse F4 provided in the connection circuit 25 is provided instead of the first fuse F1 and the second fuse F2 of the sixth modification. According to the vehicle 100H of the seventh modification, when the fourth fuse F4 is blown, the second contactor S/C_B and the third contactor S/C_C are turned on to set the battery 2 to the second voltage state (400 V startup), and the three-phase motor 3 can be driven in the second voltage state. In addition, when the first contactor S/C_A is stuck in the OFF state, the second contactor S/C_B and/or the third contactor S/C_C is stuck in the OFF state, the first contactor S/C_A is stuck in the ON state, and the second contactor S/C_B and/or the third contactor S/C_C is stuck in the ON state, it is possible to drive the three-phase motor 3 in either the first voltage state or the second voltage state by the abnormality control similar to the above embodiment.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiments may be freely combined without departing from the gist of the invention.

For example, in the above embodiment, the controller 10 performs CAN communication with the charging equipment, but the communication method is not limited to CAN communication, and any communication method can be adopted.

In the present specification, at least the following matters are described. Corresponding components and the like in the embodiment described above are shown in parentheses, but the present invention is not limited thereto.
(1) A vehicle (vehicle 100, 100C, 100E, 100G) including a drive source (three-phase motor 3), a battery (battery 2) that supplies electric power to the drive source, and a controller (controller 10) configured to control the drive source and the battery,
   in which the battery includes:
      a first power storage (first power storage 21);
      a second power storage (second power storage 22);
      a positive node (positive node 23) configured to connect in parallel a positive terminal of the first power storage and a positive terminal of the second power storage;
      a negative node (negative node 24) configured to connect in parallel a negative terminal of the first power storage and a negative terminal of the second power storage;
      a connection circuit (connection circuit 25) configured to connect the negative terminal of the first power storage and the positive terminal of the second power storage;
      a first contactor (first contactor S/C_A) provided in the connection circuit;
      a second contactor (second contactor S/C_B) and a first fuse (first fuse F1) provided between the positive node and a first connection portion (first connection portion 26) configured to connect the positive terminal of the second power storage and the connection circuit; and
      a third contactor (third contactor S/C_C) and a second fuse (second fuse F2) provided between the negative node and a second connection portion (second connection portion 27) configured to connect the negative terminal of the first power storage and the connection circuit, and
   in which the controller is configured to switch between
      a first voltage state in which the first contactor is in an on state, the second contactor and the third contactor are in an off state, and the first power storage and the second power storage are connected in series and chargeable at a first voltage, and
      a second voltage state in which the first contactor is in an off state, the second contactor and the third contactor are in an on state, and the first power storage and the second power storage are connected in parallel and chargeable at a second voltage.

According to (1), when an overcurrent occurs, the first fuse or the second fuse is blown, thereby protecting the battery. Further, even when the first fuse or the second fuse is blown, the vehicle can be driven in the first voltage state.
(2) A vehicle (vehicle 100B, 100D, 100F, 100H) including a drive source (three-phase motor 3), a battery (battery 2) that supplies electric power to the drive source, and a controller (controller 10) configured to control the drive source and the battery,
   in which the battery includes:
      a first power storage (first power storage 21);
      a second power storage (second power storage 22);
      a positive node (positive node 23) configured to connect in parallel a positive terminal of the first power storage and a positive terminal of the second power storage;
      a negative node (negative node 24) configured to connect in parallel a negative terminal of the first power storage and a negative terminal of the second power storage;
      a connection circuit (connection circuit 25) configured to connect the negative terminal of the first power storage and the positive terminal of the second power storage;
      a first contactor (first contactor S/C_A) and a fuse (fourth fuse F4) provided in the connection circuit;
      a second contactor (second contactor S/C_B) provided between the positive node and a first connection portion (first connection portion 26) configured to connect the positive terminal of the second power storage and the connection circuit; and
      a third contactor (third contactor S/C_C) provided between the negative node and a second connection portion (second connection portion 27) configured to connect the negative terminal of the first power storage and the connection circuit, and
   in which the controller is configured to switch between
   a first voltage state in which the first contactor is in an on state, the second contactor and the third contactor are in an off state, the first power storage and the second power storage are connected in series and chargeable at a first voltage, and
   contactor and the third contactor are in an on state, and the first power storage and the second power storage are connected in parallel and chargeable at a second voltage.

According to (2), when an overcurrent occurs, the fuse is blown, thereby protecting the battery. Further, even when the fuse is blown, the vehicle can be driven in the second voltage state.
(3) The vehicle according to (1).
   in which the controller drives the drive source in the first voltage state when at least one of the first fuse or the second fuse is blown.

According to (3), even when the first fuse or the second fuse is blown, the vehicle can be driven.
(4) The vehicle according to (2),
   in which the controller drives the drive source in the second voltage state when the fuse is blown.

According to (4), even when the fuse is blown, the vehicle can be driven.
(5) The vehicle according to any one of (1) to (4),
   in which the controller drives the drive source in the second voltage state when the first contactor is stuck in an off state.

According to (5), the vehicle can be driven in the second voltage state even when the first contactor is stuck in the off state.
(6) The vehicle according to any one of (1) to (4),
   in which the controller drives the drive source in the first voltage state when the second contactor or the third contactor is stuck in an off state.

According to (6), the vehicle can be driven in the first voltage state even when the second contactor or the third contactor is stuck in the off state.
(7) The vehicle according to any one of (1) to (4).
   in which the controller drives the drive source in the first voltage state when the first contactor is stuck in an on state.

According to (7), the vehicle can be driven in the first voltage state even when the first contactor is stuck in the on state.
(8) The vehicle according to any one of (1) to (4),
   in which the controller drives the drive source in the second voltage state when the second contactor or the third contactor is stuck in an on state.

According to (8), the vehicle can be driven in the second voltage state even when the second contactor or the third contactor is stuck in the on state.
(9) The vehicle according to any one of (1) to (4),
   in which the drive source is a three-phase motor (three-phase motor 3) in which coils (coils 32U, 32V, 32W) of three phases are connected at a neutral point (neutral point 31), the three-phase motor being driven by electric power supplied from the battery,
   an inverter (inverter 5) is provided on an electric power transmission path (electric power supply circuits 11P, 11N) between the battery and the three-phase motor,
   a DC power supply circuit (DC power supply circuits 13P, 13N) is connected to a connection portion (connection portions 111P, 111N) positioned on an electric power transmission path between the inverter and the battery, and
   the DC power supply circuit has a branch circuit (branch circuit 14) connected to the neutral point at a positive electrode side of the DC power supply circuit.

According to (9), since the DC power supply circuit has the branch circuit connected to the neutral point of the three-phase motor at the positive electrode side thereof connected to the connection portion positioned on the electric power transmission path between the inverter and the battery, voltage conversion can be performed using the three-phase motor and the inverter. According to (9), even when the voltage state of the charging equipment is different from an operating voltage of an auxiliary device or the like, it is possible to eliminate a dedicated voltage converter, and thus a manufacturing cost can be reduced.
(10) The vehicle according to (9), further including:
   an auxiliary device (auxiliary device 4) configured to be driven by DC electric power from the battery and an external power supply; and
   an auxiliary device drive circuit (auxiliary device drive circuits 12P, 12N) connected on an electric power transmission path between the inverter and the connection portion, and configured to supply electric power to the auxiliary device,
   in which the auxiliary device is operated at the first voltage.

According to (10), it is unnecessary to perform voltage conversion during traveling and during charging at the first voltage.
(11) The vehicle according to (10),
   in which when the battery is charged at the second voltage, the controller causes the inverter to boost a voltage supplied from the branch circuit to the three-phase motor to the first voltage.

According to (11), since voltage conversion can be performed using the three-phase motor and the inverter, it is possible to eliminate an auxiliary device voltage converter.
(12) The vehicle according to any one of (1) to (4),
   in which the drive source is a three-phase motor (three-phase motor 3) in which coils (coils 32U, 32V, 32W) of three phases are connected at a neutral point (neutral point 31), the three-phase motor being driven by electric power supplied from the battery,
   an inverter (inverter 5) is provided on an electric power transmission path (electric power supply circuits 11P, 11N) between the battery and the three-phase motor,
   a DC power supply circuit (DC power supply circuits 13P, 13N) is connected to a connection portion (connection portions 111P, 111N) positioned on an electric power transmission path between the inverter and the battery, and
   the DC power supply circuit has a branch circuit (branch circuit 14) connected to a coil (coil 32U) of one phase among the coils of three phases at a positive electrode side of the DC power supply circuit.

According to (12), since the DC power supply circuit has the branch circuit connected to a coil of one phase at the positive electrode side thereof connected to the connection portion positioned on the electric power transmission path between the inverter and the battery, voltage conversion can be performed using the three-phase motor and the inverter. According to (12), even when the voltage state of the charging equipment is different from an operating voltage of an auxiliary device or the like, it is possible to eliminate a dedicated voltage converter, and thus a manufacturing cost can be reduced.
(13) The vehicle according to (12), further including:
   an auxiliary device (auxiliary device 4) configured to be driven by DC electric power from the battery and an external power supply; and
   an auxiliary device drive circuit (auxiliary device drive circuits 12P, 12N) connected on an electric power transmission path between the inverter and the connection portion, and configured to supply electric power to the auxiliary device,
   in which the auxiliary device is operated at the first voltage.

According to (13), it is unnecessary to perform voltage conversion during traveling and during charging at the first voltage.
(14) The vehicle according to (13),
   in which when the battery is charged at the second voltage, the controller causes the inverter to boost a voltage supplied from the branch circuit to the three-phase motor to the first voltage.

According to (14), since voltage conversion can be performed using the three-phase motor and the inverter, it is possible to eliminate an auxiliary device voltage converter.

What is claimed is:

1. A vehicle including a drive source, a battery that supplies electric power to the drive source, and a controller configured to control the drive source and the battery,
wherein the battery comprises:
a first power storage;
a second power storage;
a positive node configured to connect in parallel a positive terminal of the first power storage and a positive terminal of the second power storage;
a negative node configured to connect in parallel a negative terminal of the first power storage and a negative terminal of the second power storage;
a connection circuit configured to connect the negative terminal of the first power storage and the positive terminal of the second power storage;
a first contactor provided in the connection circuit;
a second contactor and a first fuse provided between the positive node and a first connection portion configured to connect the positive terminal of the second power storage and the connection circuit; and
a third contactor and a second fuse provided between the negative node and a second connection portion configured to connect the negative terminal of the first power storage and the connection circuit, and
wherein the controller is configured to switch between
a first voltage state in which the first contactor is in an on state, the second contactor and the third contactor are in an off state, and the first power storage and the second power storage are connected in series and chargeable at a first voltage, and
a second voltage state in which the first contactor is in an off state, the second contactor and the third contactor are in an on state, and the first power storage and the second power storage are connected in parallel and chargeable at a second voltage.

2. A vehicle including a drive source, a battery that supplies electric power to the drive source, and a controller that controls the drive source and the battery,
wherein the battery comprises:
a first power storage;
a second power storage;
a positive node configured to connect in parallel a positive terminal of the first power storage and a positive terminal of the second power storage;
a negative node configured to connect in parallel a negative terminal of the first power storage and a negative terminal of the second power storage;
a connection circuit configured to connect the negative terminal of the first power storage and the positive terminal of the second power storage;
a first contactor and a fuse provided in the connection circuit;
a second contactor provided between the positive node and a first connection portion configured to connect the positive terminal of the second power storage and the connection circuit; and
a third contactor provided between the negative node and a second connection portion configured to connect the negative terminal of the first power storage and the connection circuit, and
wherein the controller is configured to switch between
a first voltage state in which the first contactor is an on state, the second contactor and the third contactor are in an off state, and the first power storage and the second power storage are connected in series and chargeable at a first voltage, and
a second voltage state in which the first contactor is in an off state, the second contactor and the third contactor are in an on state, the first power storage and the second power storage are connected in parallel and chargeable at a second voltage.

3. The vehicle according to claim 1,
wherein the controller drives the drive source in the first voltage state when at least one of the first fuse or the second fuse is blown.

4. The vehicle according to claim 2,
wherein the controller drives the drive source in the second voltage state when the fuse is blown.

5. The vehicle according to claim 1,
wherein the controller drives the drive source in the second voltage state when the first contactor is stuck in an off state.

6. The vehicle according to claim 1,
wherein the controller drives the drive source in the first voltage state when the second contactor or the third contactor is stuck in an off state.

7. The vehicle according to claim 1,
wherein the controller drives the drive source in the first voltage state when the first contactor is stuck in an on state.

8. The vehicle according to claim 1,
wherein the controller drives the drive source in the second voltage state when the second contactor or the third contactor is stuck in an on state.

9. The vehicle according to claim 1,
wherein the drive source is a three-phase motor in which coils of three phases are connected at a neutral point, the three-phase motor being driven by electric power supplied from the battery,
an inverter is provided on an electric power transmission path between the battery and the three-phase motor,
a DC power supply circuit is connected to a connection portion positioned on an electric power transmission path between the inverter and the battery, and
the DC power supply circuit has a branch circuit connected to the neutral point at a positive electrode side of the DC power supply circuit.

10. The vehicle according to claim 9, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage, and
when the battery is charged at the second voltage, the controller causes the inverter to boost a voltage supplied from the branch circuit to the three-phase motor to the first voltage.

11. The vehicle according to claim 1,
wherein the drive source is a three-phase motor in which coils of three phases are connected at a neutral point, and the three-phase motor being driven by electric power supplied from the battery,
an inverter is provided on an electric power transmission path between the battery and the three-phase motor,
a DC power supply circuit is connected to a connection portion positioned on an electric power transmission path between the inverter and the battery, and
the DC power supply circuit has a branch circuit connected to a coil of one phase among the coils of three phases at a positive electrode side of the DC power supply circuit.

12. The vehicle according to claim 11, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage, and
when the battery is charged at the second voltage, the controller causes the inverter to boost a voltage supplied from the branch circuit to the three-phase motor to the first voltage.

13. The vehicle according to claim 2,
wherein the controller drives the drive source in the second voltage state when the first contactor is stuck in an off state.

14. The vehicle according to claim 2,
wherein the controller drives the drive source in the first voltage state when the second contactor or the third contactor is stuck in an off state.

15. The vehicle according to claim 2,
wherein the controller drives the drive source in the first voltage state when the first contactor is stuck in an on state.

16. The vehicle according to claim 2,
wherein the controller drives the drive source in the second voltage state when the second contactor or the third contactor is stuck in an on state.

17. The vehicle according to claim 2,
wherein the drive source is a three-phase motor in which coils of three phases are connected at a neutral point, the three-phase motor being driven by electric power supplied from the battery,
an inverter is provided on an electric power transmission path between the battery and the three-phase motor.
a DC power supply circuit is connected to a connection portion positioned on an electric power transmission path between the inverter and the battery, and
the DC power supply circuit has a branch circuit connected to the neutral point at a positive electrode side of the DC power supply circuit.

18. The vehicle according to claim 17, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage, and
when the battery is charged at the second voltage, the controller causes the inverter to boost a voltage supplied from the branch circuit to the three-phase motor to the first voltage.

19. The vehicle according to claim 2,
wherein the drive source is a three-phase motor in which coils of three phases are connected at a neutral point, and the three-phase motor being driven by electric power supplied from the battery,
an inverter is provided on an electric power transmission path between the battery and the three-phase motor,
a DC power supply circuit is connected to a connection portion positioned on an electric power transmission path between the inverter and the battery, and
the DC power supply circuit has a branch circuit connected to a coil of one phase among the coils of three phases at a positive electrode side of the DC power supply circuit.

20. The vehicle according to claim 19, further comprising:
an auxiliary device configured to be driven by DC electric power from the battery and an external power supply; and
an auxiliary device drive circuit connected on an electric power transmission path between the inverter and the connection portion, and configured to supply electric power to the auxiliary device,
wherein the auxiliary device is operated at the first voltage, and
when the battery is charged at the second voltage, the controller causes the inverter to boost a voltage supplied from the branch circuit to the three-phase motor to the first voltage.
